(19) United States
(12) Patent Application Publication
(10) Pub. No.: US 2010/0139148 A1
(43) Pub. Date: Jun. 10, 2010

(54) FLOATING CHUM DELIVERY DEVICE

(76) Inventor: Clay S. Barker, Plantation, FL (US)

Correspondence Address: ROBERT M. SCHWARTZ, P.A., P.O. BOX 221470, HOLLYWOOD, FL, 33022, US

(21) Appl. No.: 12/634,763

(22) Filed: Dec. 10, 2009

Related U.S. Application Data
(60) Provisional application No. 61/262,978, filed on Nov. 20, 2009.
(60) Provisional application No. 61/121,257, filed on Dec. 10, 2008.

(51) Int. Cl. A01K 97/02; A01K 99/00

(52) U.S. Cl. 43/4.5; 43/44.99

(57) ABSTRACT

A device and method is for providing fishing chum, over an extended period of time, to a body of water.

### INDEX TO RELATED REFERENCES

This application claims benefit of U.S. Provisional Patent No. 61/121,257 filed Dec. 10, 2008 and U.S. Provisional Patent No. 61/262,978 filed Nov. 20, 2009, the disclosures of which are incorporated herein by reference in their entirety.

### BRIEF SUMMARY OF THE INVENTION

The present invention provides a device and method for delivering chum to a body of water over an extended period of time.

### BRIEF DESCRIPTION OF THE DRAWINGS

FIG. 1 is side view of the device in an environment of use.

FIG. 2 is a partial side cut away of the portion of device.

FIG. 3 is a cross section of a portion of the device.

FIG. 3A is a view along section lines B-B from FIG. 3

FIG. 4 is a partial side cut away of the portion of device from FIG. 5 with arrow indicating placement.

FIG. 5 is a cross section of a portion of the device.

FIG. 6 is a bottom view of the device with the lowermost light assembly removed.

FIG. 7 shows the device with a flexible or fabric material attached.

FIG. 8 is a partial cross section along section lines C-C from FIG. 1.

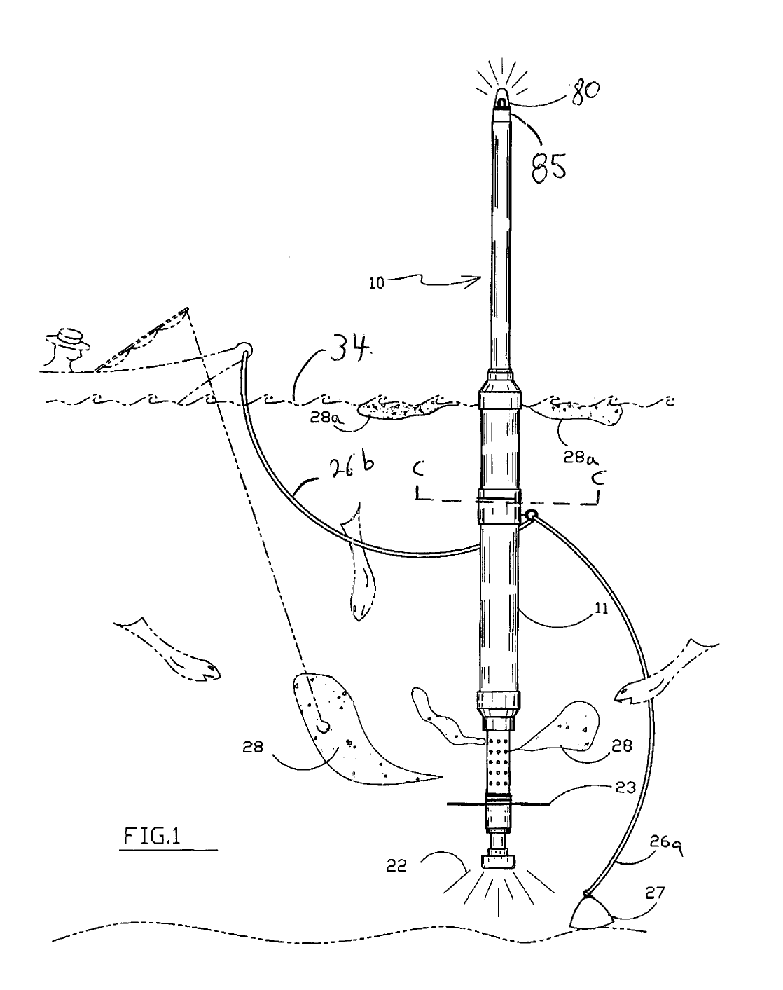

### DETAILED DESCRIPTION OF THE PREFERRED EMBODIMENTS

The present invention is a chum tube 10 with portions that rest above and below the water line 34 of a body of water. The portion extending above the water line is light extension tube 16 and has a strobe light 80 on its uppermost end. Extending upward from tube 11 is cap 15 upon which light extension tube 16 is affixed.

Cap 15 is on the upper end of tube 11. On the interior of tube 11 is air chamber 13 that is bordered on its base by an interior floor 14, bordered on either side by the interior wall of tube 11, and bordered in the uppermost edge by cap 15.

Below interior floor 14 within tube 11 is an inner cylindrical tube 12 slidably contained therein.

Chum material 31 is placed within inner cylindrical tube 12. Inner cylindrical tube 12 is held into an initial fixed position by a medial set screw 25 that applies pressure on one side of inner cylindrical tube 12 and urges inner cylindrical tube 12 against inner portion of wall 11 in a direction opposite medial set screw 25 to seal opening 24 during filling and transport. Closure is accomplished by contact of the outer wall of cylindrical tube 12 against the inside wall of tube 11 sealing opening 24 when screw 25 is tightened against cylindrical tube 12. It is preferred that opening 24 be sealed during filling and transport of chum tube 10. Preferably, screw 25 is loosened when chum tube 10 is used such that chum exits opening 24. Opening 24 is not accessible when screw 25 is engaged because opening 24 is sealed. When screw 25 is disengaged, a chum oil and water mixture 28 exits device 10.

Chum mixed with water produces an oil water mixture 28. Oil is lighter than water and tends to float. Oil from chum 31 exits through opening 24 and openings 20.

The lower portion of chum tube 10 has a plate 23 at the lower end. Plate 23 is connected to cylindrical tube 12 and is constructed and arranged to move cylindrical tube 12 in an up and down motion from water movement.

In one embodiment, plate 23 is formed of a photosensitive material that is at least partially luminescent in light. More particularly, in sunlight, plate 23 appears to glow and the luminescence of plate 23 attracts fish.

Lower tube openings 20 provide openings for chum material 28 to exit cylindrical tube 12 and ultimately provide chum into the surrounding lower water areas around openings 20.

Inner cylindrical tube 12 has, at its lower end, inner cylindrical tube cap 21 which has affixed thereto, lower strobe light 22. Tube cap 21 has a circumferal threaded portion 32 that is constructed and arranged to attach to threaded portion 33 on the lower end of tube 12.

Chum tube 10 is constructed and arranged to float freely. It is also held in place by anchor line 26a attached on one end to anchor 27 and on an opposite end to medial set screw 25. Additionally, anchor line 26b can be attached to a boat.

In use, cylindrical tube cap 21 is removed to access the open end of inner cylindrical tube 12. The top of tube 12 is open providing access to the cavity within tube 12. The bottom of tube 12 has cylindrical tube cap 21 that forms the bottom floor portion of the cavity in tube 12. The cavity is filled with dry chum 31 and tube 12 is replaced. Any acceptable chum is used. The chum may be a solid, semisolid, liquid, or combinations thereof. A preferred chum is Drychum Concentrate (JanDell Fishing Products, Boyd Tex.).

Tube 12 slides into tube 11 at opening 19. Collar 30 prevents tube 12 from sliding out of tube 11

After chum 31 is loaded into chum tube 10, it is desirable to tighten screw 25 to prevent chum 31 from exiting chum tube 10 until a desirable time. Screw 25 is preferably an eyebolt that is easily tightened and loosened by hand. A lanyard can be used to secure screw 25 to both tube 11 and the eyelet portion of screw 25.

As discussed herein, screw 25 prevents chum 31 from exiting opening 24 until such time as desired by pushing cylindrical tube 12 against and sealing opening 24.

Tube 11 is preferably formed of schedule 40 PVC pipe. Schedule 40 PVC is selected due to various characteristics including, but not limited to the fact that it floats in water. In a preferred embodiment, tube 11 is constructed and arranged to be about 18 inches long and to have an inner diameter of about 3 inches.

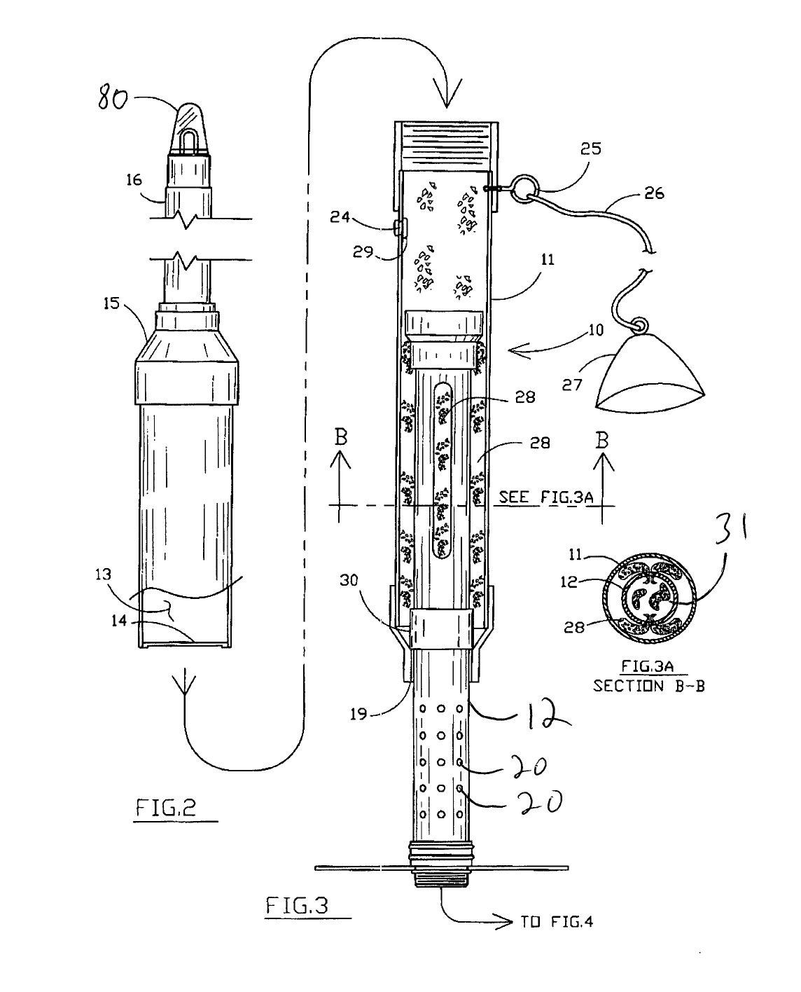

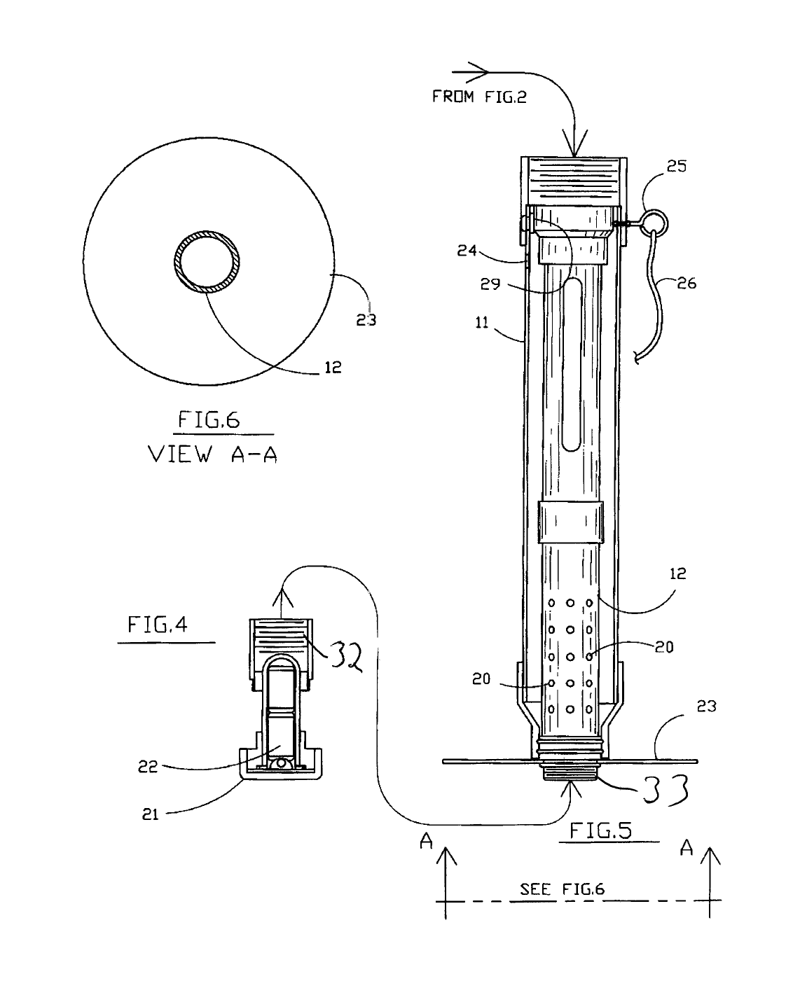

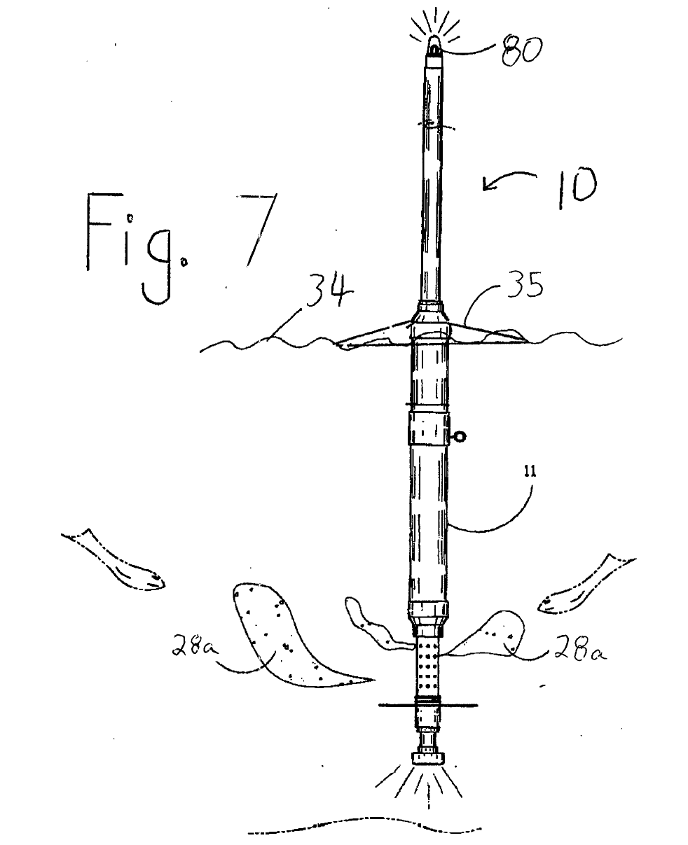

The upper portion of tube 11, as seen in FIG. 2 has air tight interior chamber 13. Airtight interior chamber 13 prevents tube 10 from sinking and maintains tube 10 at a desired position relative to water line 34.

As shown in FIG. 8, tube 11 has upper collar 11a. Collar 11a is constructed and arranged to support spacer 55. When spacer 55 is positioned on collar 11a of tube 11, screw threads 50 remain accessible for eventual connection with lower collar 11c on lower tube end 11b. Lower collar 11c has complementary receiving threads 65, as shown in FIG. 8, for connection of upper collar 11a to lower collar 11c utilizing complementary screw thread connections 50 and 65.

Light extension tube 16 is preferably formed of schedule 20 PVC. Light extension tube 16 is preferably about 24 inches long and has an inner diameter of about 1.25 inches.

Plate 23 is formed of a fluorescent neon green plexiglass that attracts fish because, in the daytime sunlight, plate 23 refracts light. The refracted light acts as a fish attractor. This refracted light appears to move and is attractive to fish by the natural movement and bobbing of tube 10 when floating in water.

In a preferred embodiment, chum tube 10 has affixed thereon an ACR strobe light 80, on top of light extension tube 16.

Chum tube 10 is set on the water. Air chamber 13 keeps chum tube 10 afloat and any one or more of anchor line 26a, anchor line 26b, or anchor 27 keeps chum tube 10 in an area restricted by the length of anchor line 26a or 26b.

In use, cap 21 is removed from tube 11, as shown in FIGS. 4 and 5. Chum 31 is placed within tube 12 and cap 21 is replaced. Chum tube 10 is set on the water. Water enters chum tube 10 through openings 20 and chum 31 subsequently mixes with water that has entered. A mixture of chum and water 28 exits inner cylindrical tube 12 through openings 20 and 24. Openings 20 are only exposed to the surrounding water when tube 12 extends past below the periphery of interior wall 11 of chum tube 10. Chum mixture 28 comprises oil and will eventually form surface chum 28a that will float on or near the water surface 34.

The chum that exits openings 20 and 24 attracts fish, as chum is known to accomplish.

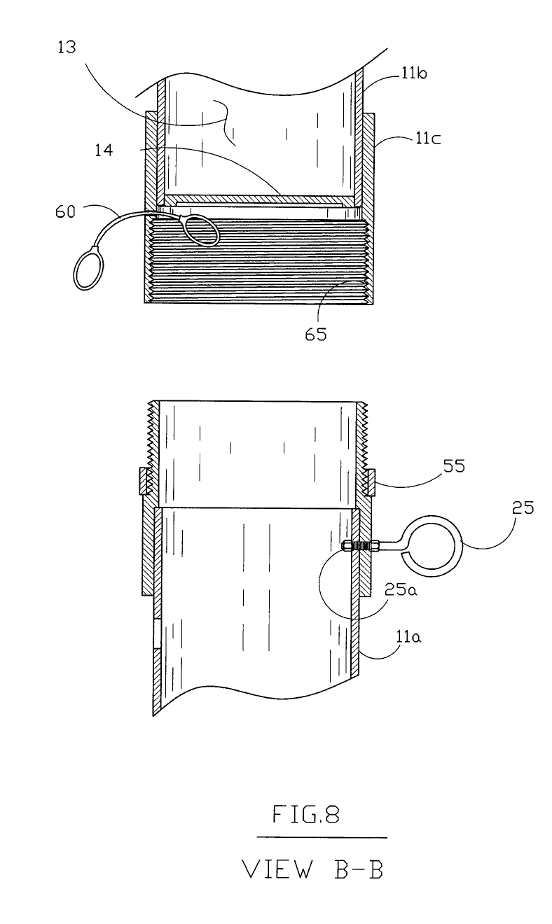

In one embodiment, depicted in FIG. 7, a fabric or flexible material 35 is attached to device 10. The material floats and is intended to attract fish.

While the invention has been described in its preferred form or embodiment with some degree of particularity, it is understood that this description has been given only by way of example and that numerous changes in the details of construction, fabrication, and use, including the combination and arrangement of parts, may be made without departing from the spirit and scope of the invention.

We claim:

1. A device for delivering chum comprising:
a. a first hollow tube;
b. a second hollow tube constructed and arranged to slidably move inside said first tube;
c. at least one orifice in said second tube;
d. a collar on said second tube to restrict second tube from being removed from said inside of said first tube.

2. The device of claim 1 wherein said first hollow tube is constructed and arranged with at least one airtight interior chamber to facilitate flotation of said device.

3. The device of claim 1 wherein said second hollow tube is constructed and arranged with an interior cavity to contain chum.

4. The device of claim 1 wherein said second hollow tube is constructed and arranged with an interior cavity to receive water in an environment of use and release a mixture of chum and water.

5. A method of delivering chum to a body of water comprising:
a. providing a device of claim 1;
b. filling said second hollow tube with chum;
c. placing said device in a body of water;
said placing of said device providing interaction between chum and water such that chum and/or chum oil exit the device through said orifice.
